(19) United States
(12) Patent Application Publication
(10) Pub. No.: US 2002/0090047 A1
(43) Pub. Date: Jul. 11, 2002

(54) Apparatus for producing ecologically clean energy

(76) Inventor: Roger Stringham, Woodside, CA (US)

Correspondence Address: FINLEY & BERG, LLP, 455 MARKET STREET, SUITE 1940, SAN FRANCISCO, CA, 94105-2448, US

(21) Appl. No.: 09/918,969

(22) Filed: Jul. 30, 2001

Related U.S. Application Data
(63) Continuation of application No. 09/103,043, filed on Jun. 23, 1998, now abandoned.
Application No. 09/103,043 is a continuation-in-part of application No. 08/814,637, filed on Mar. 10, 1997, now abandoned.
Application No. 08/814,637 is a division of application No. 08/340,256, filed on Nov. 16, 1994, now abandoned.
Application No. 08/340,256 is a continuation-in-part of application No. 08/160,941, filed on Dec. 3, 1993, now abandoned.
Application No. 08/160,941 is a continuation-in-part of application No. 07/782,558, filed on Oct. 25, 1991, now abandoned.

(51) Int. Cl. G21J 1/00; G21B 1/00

(52) U.S. Cl. 376/100

(57) ABSTRACT

A device and a method for performing cavitation energy generation includes a reaction vessel or volume containing a deuterium rich or other hydrogen isotope material along with a metal having certain lattice structures that will accept hydrogen or hydrogen isotope atoms within the lattice framework of the metal for either transient time periods or permanently. In order to provide atomic hydrogen or atomic hydrogen isotopes to the lattice structure and further to bring the various hydrogen atoms into close proximity so high energy reactions may occur, a sonicator provides high energy sound waves to the relatively incompressible liquid containing liquid deuteriumoxide or heavy water and other deuterium containing liquids and also dissolved deuterium or other hydrogen isotopes and/or noble gases. The sonicator causes cavitation bubbles to form adjacent to the metal utilized in the device. Such cavitation bubbles upon collapse create local high temperatures and high pressures directing a plasma-like jet into the metal lattice thereby resulting in combination within the metal lattice. The results of such events are the generation of excess heat and the corresponding heat production, along with levels of radiation equivalent to background levels.

This application is a continuation-in-part of application Ser. No. 08/814,837, filed Dec. 10, 1997 which is a division of application Ser. No. 08/340,256 filed on Nov. 16, 1995 (now abandoned) which is a continuation in part of U.S. application Ser. No. 07/782,558 filed on Oct. 24, 1991 by inventor Roger S. Stringham for An Apparatus for Producing Ecologically Clean Energy.

### TECHNICAL FIELD

This invention relates to the production of energy through unique nonradiative interactions. In particular, it relates to nuclear interactions obtained at relatively low temperatures through the use of transient cavitation bubbles.

### BACKGROUND OF THE INVENTION

The quest for a clean alternate energy process has a relatively long history. The first steps in this direction occurred in the 1920's when European scientists theorized that particular metals having certain lattice structures would accept into the lattice framework of the metal hydrogen atoms. The hydrogen atoms, because of the nature of the lattice structure of the receiving metal, would bring into close proximity one atom with another with the resultant fusion of the atoms. The product of the fusion would, of course, include heat, helium 3, tritium and possibly helium 4, and certain radioactive decay particles, depending upon the reaction.

With the advent of research into the workings of the nucleus during the 1940s and 50s the high energy reaction requiring 10's of millions of degrees ° K showed by these products. In 1989, Pons and Fleischmann announced to the world that they had achieved fusion without the imposition of heat several hundred million degrees Kelvin using an electrochemical device wherein a platinum anode and palladium cathode were positioned in a cell containing heavy water or deuterium oxide and an electrolyte to produce anomalous heat. The Pons and Fleischmann experiment has been discredited by some of the scientific community as not being reproducible. Nevertheless, Pons and Fleischmann filed a patent application with the World Intellectual Property Organization. Such patent application has been published and carries the International Publication No. WO90/10935.

At about the same time, Peter L. Hagelstein of the Massachusetts Institute of Technology applied for a fusion apparatus which resulted in “coherent fusion.” The Hagelstein data is contained in PCT Application WO90/13129.

Among others, Alan Bernstein has filed and published PCT Application WO91/01037.

(1) On Mar. 4, 1989 Yasuyuki Sugano has filed and obtained a patent JP 2-281185 for “A Normal Temperature Nuclear Fusion Supersonic Wave Acceleration Method”.

(2) On Aug. 5, 1990 Akihiro Fujimura filed and obtained a patent JP 3-67196 for a “Nuclear Fusion Experimental Apparatus”.

(3) On Jun. 21, 1989 Richard Pavelle has filed and obtained a patent U.S. Pat. No. 4,968,395 for a “Method and Apparatus for Increasing Catalytic Efficiency of Electrodes”.

(4) On Jul. 21, 1989 Masao Kasahara has filed and obtained a patent JP 3-53195 for an “Apparatus for Energy Generation”.

On Jun. 8, 1982, Hugh G. Flynn has filed and obtained U.S. Pat. No. 4,333,796, for a “Method of Generating Energy by Acoustically Induced Cavitation Fusion and Reactor Therefor.”

These patents (1, 2, 3, and 4) use an electrolyte such as LiOD to increase the conductive properties of water so that a modified electrochemical cell, in the likeness of the Pons and Fleischmann device, according to their description produces heat with the accompanying gammas and neutrons. The clean alternate energy is not present in the use of these devices and gammas and neutrons. The clean alternate energy is not present in the use of these devices and although the cavitation is introduced to these electrochemical devices as an adjunct to there operation, these devices with their electrodes and electrolytes look to DD fusion and the respective hot fusion products as the source of their heat generation.

The Pons and Fleischmann experiment, as noted above, is characterized by the use of palladium and platinum electrodes in a deuteriumoxide and electrolyte bath. Hagelstein (PCT Application WO90/13129) teaches a “coherent fusion apparatus” which includes a source of fusionable material; for example, deuterium, and a means for exciting that material to initiate and sustain “coherent” fusion. It also includes means for monitoring a rate of “coherent” fusion through the use of a proton, a neutron or alpha particle detector and a means for extracting usable energy from the coherent fusion apparatus. The Hagelstein application makes mention of a “variable quality (Q) factor resonator for acoustical excitation of fusionable material including hydrogen or deuterium in proportions adjusted for optimization of ‘coherent’ fusion rate.” Hagelstein suggests acoustical excitation in the sense of disturbing or moving the lattice structure of the palladium so that the structure resonates. He later postulates that deuterons that have migrated into the lattice structure will, by the use of resonating energy (not limited to acoustics) be brought into close proximity one with another and thereby fuse. This reference is at page 3 of the PCT application. There is no further mention or teaching of the use of acoustic energy by Hagelstein. Hagelstein does, however, claim in one of the dependent claims that the energy source utilized is the application of acoustical vibration.

Bernstein in WO91/01037 introduces controlled amounts of deuterium molecules into a chamber to come in contact with deuteriumoxide and a palladium catalyst such that the deuterium molecules are adsorbed by the palladium catalyst. Thus, Bernstein merely teaches the mixture of deuterium gas with a palladium catalyst such that the effect of the adsorption energy exerts tremendous compressive forces resulting in the collapse of the deuterium nuclei upon each other. Flynn (U.S. Pat. No. 4,333,796) teaches a thermonuclear event taking place in a liquid metal via the collapse of a cavitation bubble creating the temperature and pressure environment for such an event.

This invention overcomes the shortcomings of the described inventions above and other disclosures. In particular, this invention uses as its principle energy source a high frequency transducer to form cavitation bubbles in deuteriumoxide (heavy water) contained in the reaction vessel. Also contained in the reaction vessel is a metal, preferably in the form of a foil where cavitation bubbles may impinge upon the surface thereof where the resultant rapid collapse of the cavitation bubbles forces atomic deuterium into the lattice framework of the metal. The dissociated deuterium in the bubble has its temperature raised to something between 20,000° and 1,000,000° Kelvin due to heat generated by the rapid collapse of the cavitation bubble. The atomic deuterium, at a high temperature, then results in a combination reactions with adjacent atomic deuterium residing in the metal lattice to yield He4 without the accompanying long range radiation.

### BRIEF DESCRIPTION OF THE DRAWINGS

FIG. 1 is a schematic of a double chamber anomalous heat producing apparatus as described herein.

FIG. 2 is an enlarged view of the dual chamber reaction vessel (volume) shown in FIG. 1 for use in the anomalous heat producing process.

FIGS. 3A & B is a projected view of the window and related elements as shown in FIG. 2 in an exploded relation.

FIG. 4 is an alternate embodiment using a single chamber and a single piezo.

FIG. 5 is a second alternate embodiment using numerous small single chamber piezo devices.

FIG. 6 is a third alternate embodiment using a single chamber device coupled to thermoelectric device.

FIG. 7 is a fourth alternate embodiment is a simplified high pressure device using opposing.

FIG. 8 is projected view of the reactor of the fourth alternate embodiment and related in an exploded relation.

### DETAILED DESCRIPTION OF THE PREFERRED EMBODIMENT

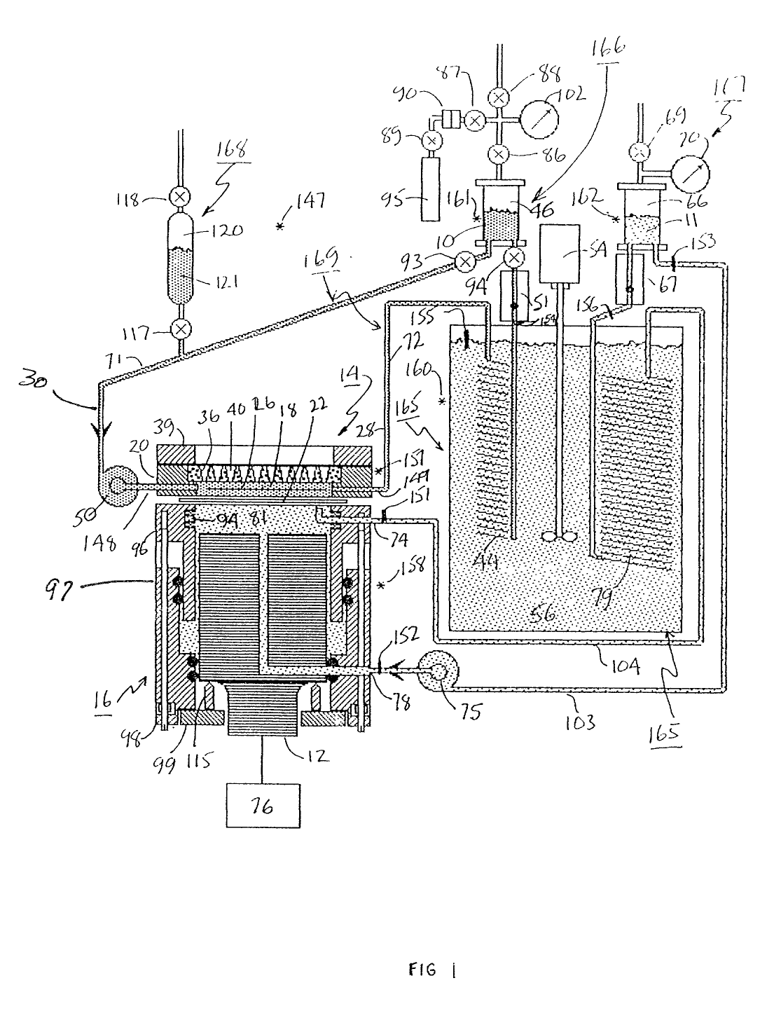

The alternate apparatus discussed herein consists of five principle systems which provides a convenient way to discuss the calorimetry of the preferred embodiment. Referring to FIG. 1, transient bubble cavitation generator or sonication containment device 16 is shown along with reaction volume or containment device 14; heat exchanger 165 that stores the heat generated in 14 and 16; bubbler and gas sampling system 166 that removes entrained bubbles from the circulating D2O and provides for sampling the gas in the reactor volume; and a bubbler system 167 that removes entrained bubbles from the circulating H2O and maintains N2 pressure in the sonication volume 81. These five systems are shown generally in FIG. 1.

The creation of transient cavitation bubbles can be done in one of several mechanical methods. The use of a piezo device to drive acoustic horn 12 is an efficient method for generating acoustic field in H2O as shown in FIG. 1. The sonication volume 81 is pressurized with N2 in bubbler containment 66 to suppress the formation of cavitation bubbles but allows for the acoustic energy transport through the stainless steel disk 22 separating 81 from the reaction volume 18. Separation of the sonicator from the reaction volume 14 is necessary when the sonicator horn 12 can be adversely affected by solubilized deuterium gas and transient cavitation bubbles. This is particularly true with titanium immersed in water with hydrogen or hydrogen isotopes which readily form hydrides.

Another way to create transient cavitation bubbles would be to use a jet, venturi tube, mechanical or porous device relying on a flow-through pressure differential to create the bubbles. There are also natural ways to create transient cavitation bubbles such as stirring, dropping, or shaking the material contained in the reaction chamber 14. Upon collapse of the transient cavitation bubbles, extremely high temperatures and pressures and energy densities may be formed at a metal surface. More will be said about this in the ensuing discussion. There are other ways to impart high energy densities to metal surfaces such as by using micro-explosive, electric, or laser techniques.

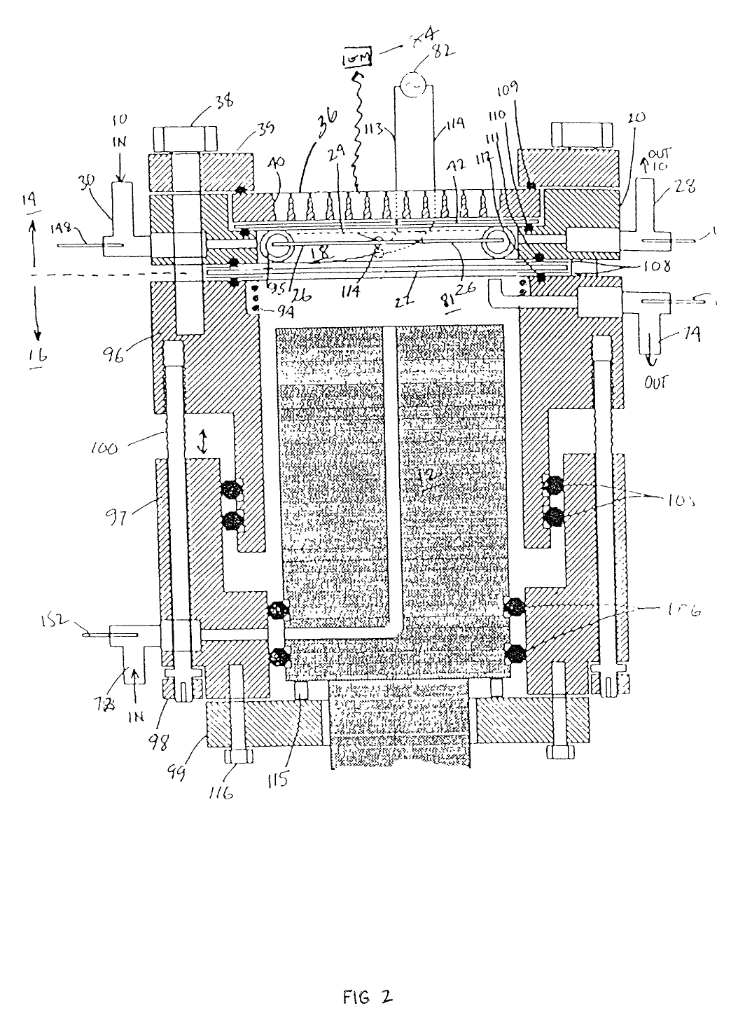

The reaction containment device 14 consists of a reaction volume 18 composed of stainless steel or other appropriate metal which will withstand pressure. This is shown in FIG. 2 as a reaction volume 18 defined by elements 20, 22, 36 and 42. The reaction volume side is formed by the stainless steel containment ring 20 which is sandwiched between the ½ inch Al window support 36, which defines a plurality of holes 40, and FEP window 42 (Fluorinated polymers such as FEP (fluoroethylene polymer- or Teflon®-fluorinated polytetrafluoroethylene- hereinafter, such material will be referred to as FEP or Teflon®.) and the stainless steel disk 22. Six ½ nylon bolts 38 fasten the reaction volume containment to sonication containment with the help of ring clamp 39. The metal plate 22 is electrically isolated by FEP gaskets 108 and can also act as one of two alternating electrically charged plates. The opposite alternatively electrically charged plate 24 is formed of a stainless steel screen so that the circulating D2O 10 is electrically isolated in reactive volume 18 by FEP window 42 and FEP shield 25. Positioned between the charged plate 22 and a charged screen 24 is a metal foil lattice matrix 26. The metal foil is held in place in the reaction volume 26 by metal foil holder 27. In the mechanism that will be discussed, the metal foils can form hydrides that range from transient to permanent hydrides. This includes all metals in the periodic table. Metals that have been successfully tried are copper (Cu), nickel (Ni), titanium (Ti), palladium (Pd), silver (Ag). In the light of successful generation of excess heat from these metals the different lattice structures of the metal do not play an important part. The reason is the collapsing bubble is a momentary self-contained micro particle accelerator. The bubbles that collapse randomly by way of a jet mechanism at the foil surface inject a plasma produced from the dissociated bubble contents into the metal lattice. This momentary injection of particles into the metal produces a high local concentration of hydrogen ions in the metal lattice thus a local stable or unstable hydride. Preferably, this metal is in the form of a foil, but it may take other forms such as particles, a grid or screen, a “wool” like structure, or a thin film or plated material.

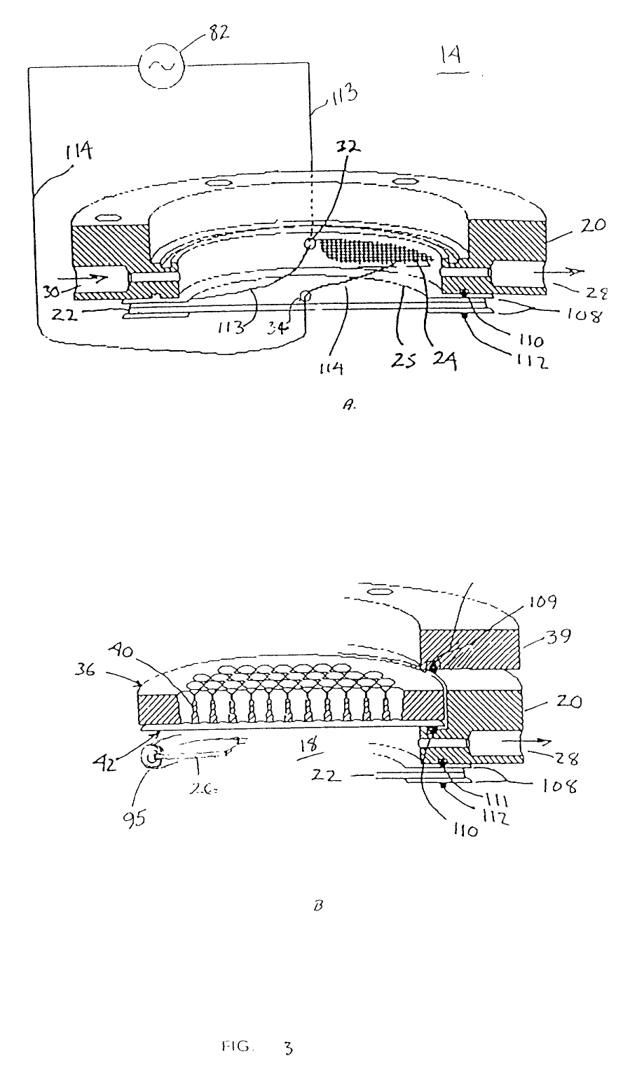

Circulated through the volume 18 is a mixture preferably of deuteriumoxide (D₂O). Other materials which may be used to circulate through the volume include hydrogen (H₂), hydrogen oxide (H₂O), deuterium (D₂), hydrogen deuteriumoxide (HDO) or mixtures thereof either in a gaseous or liquid form or other deuterated liquids, and other metal alloys and complexes. Such other deuterated liquids for cold systems may include liquid deuterium, liquid deuterated methane, ethane, and other linear alkanes, and liquid metallic hydrides where the hydrogen atom or atoms is replaced by the hydrogen isotope deuterium. For hot systems, other deuterated liquids may include liquid paraffins, liquid silicones and liquid metallic hydrides having relatively high melting points, again where at least one hydrogen atom is isotopic hydrogen. This material is introduced into the reaction chamber by means of conduit 71 and removed from reaction chamber 18 by conduit 72. As can be seen in FIG. 1, set 90° to input port 30 in reaction vessel body 20 are two ports 113 and 114 in FIG. 3A, which serves to introduce the electrical connection 32 leading to alternatively electrically charged screen 24 (see FIG. 3a) and to introduce the electrical connection 34 leading to lower alternatively electrically charged plate and insulated separator disk 22.

Closing the top of reaction vessel body 20 is a perforated plate 36 which is affixed, for example, by means of electrically insulating nylon bolts 38 and a ring 39, to reaction vessel body 20. Formed through the plate 36 are a plurality of conically shaped holes 40. The conical shape, as can be seen in FIG. 2, has its apex pointed downwardly or adjacent to a plate 42 which may be transparent to light and in that case 36 provides support for the window 42 allowing for the passage of light and a view of the foil 26. Plate 42 may, for example, be formed plastic, such as Teflon® or FEP, or other material. Use of a stainless steel plate 42 will increase the total cavitation in the reaction vessel because of the reflection of the sonic waves.

Referring again to FIG. 1, it can be seen that conduit 28 may be interconnected with a coil 44 while conduit 30 may be interconnected to a vessel 46 where a gas may be introduced into the liquid circulated through reaction vessel 18. A thermocouple 148 is provided to measure the temperature of fluid entering through conduit 30 into the reaction vessel 18, and another thermocouple 149 is provided to measure the temperature of fluid leaving through conduit 28 from the reaction vessel 18. Finally, a circulating pump 50 and a flow meter 51 are provided to circulate fluid or liquid into the gas bubbler 166 past thermocouple 148, through the reaction vessel past the thermocouple 149, then subsequently to the cooling coil 44, flow meter 51, and then gas bubble 166. The reaction volume 18 is made vacuum tight with the use of “O” rings 109, 110, and 111. The alternating electrically charged plate is insulated by flat FEP gaskets 108 from containment ring 20 and sonication containment 96 from stainless steel plate 22 and the alternating electrically charged screen 24 is insulated from window support 36 and metal foil 26. Cooling coil 44 may be positioned in a heat exchanger 165. An agitator 54 may also be utilized to stir the cooling liquid 56 contained in heat exchanger 165 alternating electrically charged plates. The addition of D₂O from the pressurized D₂O reservoir 121 is accomplished by opening valve 117. A metered amount of D₂O is added to reaction vessel 18 and the circulating pump 50 is started to circulate the D₂O through the cooling coil 44, through the flow meter 51, and into the gas bubbler containment 46. The D₂O then flows through the conduit 71 into pump 50, past the thermocouple 148 into the reaction volume 18, past thermocouple 149, and back to the cooling coil 44 to complete the heat transfer cycle.

Means are provided to introduce argon gas from the vacuum and gas handling system (not shown) by opening valves 88 and 86 accessing the D₂O bubbler 166. The evacuated sample flask 95 provides for a portion of the gas 46 over the D₂O to be checked for the presence of helium and the like in a mass spectroscopic analysis. More will be said about this process in the operation of the preferred embodiment.

Referring again to FIG. 1, there also exists a second fluid source 11 to provide a cooling for the acoustic horn 12. Cooling coil 79 may be positioned in a heat exchanger 165. A bubbler for the H₂O system 167 is pressurized with nitrogen. The addition of N₂ is accomplished by opening valve 69 changing the pressure over the H₂O in fluid source or cooling liquid 11. The flow meter 67 measures the flow rate of H₂O through the bubbler 167 and the sonication volume system 16. This pressurized system regulates the pressure in the circulating cooling liquid 11 and the pump 75 regulates the flow. The sonication volume system 16 that contains the liquid 11 is a vacuum tight system. The cooling liquid 11 is circulated through input conduit 78, through horn 12 and into the chamber 81 containing the acoustic horn device 12 by means of a circulating pump 75 and withdrawn through an outlet conduit 74. The acoustic generator in the preferred embodiment is a sonicator made by Heat Systems, 1938 New Highway, Farmingdale, N.Y. 11735, Model No. 475. This particular model number drives a 2.5″ titanium horn at 20 KHz.

The two charged surfaces stainless steel plate screen 22 and 24 may be supplied by an alternating electric field from a signal generator 82 supplied by Viz 335 East Price Street, Philadelphia, Pa. 19144. It is pointed out that the frequency selection for both the current in the plate and screen circuit just described and the sound frequency in the sonicator are not necessarily limited to the 20 Khz range, nor is it necessary that the frequencies should be the same or synchronized. Accordingly, other frequencies for both the charged plate and screen feature herein and also the sonicator frequency could be used equally as well.

It has been found appropriate to include a Geiger-Mueller counter 84 to check for the presence of gamma rays and other possible long range radiation products in the circulating fluid passing through the reaction chamber 18, though FEP window 42, and through window holes 40. This affords the least blockage to any radiation source in reaction volume 18. Since gamma rays will penetrate FEP relatively easily, the counter can be located outside the pressure vessel.

Analysis of He evolved during the process involves removing some of the gas from bubbler 166 which has accumulated He from reaction vessel 18. This gas is collected in the evacuated sample flask 95 for mass spectral analysis with the amount calculated from the gas pressure and calibrated volume relationships (PV=nRT). The analysis for He is presented in PPM of the total gas present in bubbler 46.

When a gas sample is collected after a run, the apparatus valves 94, 93 and 86 are closed and the valves 87, 88 and 89 are opened so that the collection flask 95 may be evacuated. Closing valve 88 and then opening valve 86 adds a portion of the gas bubbler 46, which may contain small amounts of generated gas, to the collection flask 95, which after closing valves 87 and 89, is removed from the system for analysis.

FIG. 2, shows the atomic matrix or metal foil 26 is supported in the chamber by Teflon® supports 95. As shown in FIG. 2, the Teflon® supports are in contact with the separation plate 22 and window 42 and window support 36 maintaining the foil outer edges bound. This allows for the foil to resonate at it natural frequency as its is driven by the acoustic input frequency.

The containment of the acoustic horn generator 12 and the acoustic horn generator coolant 11 consists of a sonication volume 81 composed of stainless steel or other appropriate metal which will withstand the cavitation and pressure. This is shown in FIG. 2 as a vessel defined by elements 22, 96, 97, 100, and 12. In the upper portion of the acoustic horn generation device 12, metal plate 22, sealed by “O” ring 112 and “O” gasket 108, is placed so that some of the sonic energy generated in sonication volume 81 in the acoustic horn generation device will be transmitted to a fluid contained in the reaction volume 18. The bottom plate 99 fastens the horn 12 in place by bolts 116.

Circulated through the sonication volume 81 is the acoustic energy transmitting fluid and coolant 11 which is coolant water. The containment of acoustic horn generating device 12 is such that the distance of the top of generating device 12 from 22 can be controlled by adjustment screws 100. The proper adjustment of distance will maximize the acoustic energy transfer through 22 to the volume reaction 18. The cylindrical containment of sonication volume 81 allows for the expansion or contraction of the sonication volume 81 with the system pressurized via the nitrogen gas from the gas handling and vacuum line (not shown) delivered by valve 69. This movable containment is constructed of two pieces. The top part 96 of the containment is held stationary while the bottom part 97 is able to slide on a set of double sealing “O” rings 105. The bottom part 97 and the horn 12 movement are controlled by screws 100 to the preferred position. The adjustment screws are held in place by fastening ring 98 to give the screws their purchase for moving 97.

For calibration and high temperature runs a Joule heater 94 (stainless steel heating element) is coiled at the inside top edge of upper sonication containment 96. The calibration of the device is performed by using the Joule heater input in place of the acoustic input long enough to establish steadystate conditions in all components. The basis of the calibration runs is for comparative purposes establishing the presence of anomalous heat production.

To hold in place the horn 12 and the sonication volume 81, a bottom plate 99 is provided, being bolted to the sonication volume containment piece 97 by bolts 116. An acoustic buffer 115 is in place between the acoustic horn 12 and the bottom plate 99 to reduce the acoustic loss through the bottom plate. The horn 12 was sealed using a set of double sealing “O” rings 106 placed at a node of the horn. Horn 12 was purchased from Heat Systems—Ultrasonics, Inc., part number 431A, a 2.5″ horn.

It can be seen in FIG. 2 that the temperature of the circulation liquid 11 can be monitored by the input thermocouple 152 and the output by thermocouple 151. Referring to FIG. 1, a circulating pump 75 is provided to circulate the coolant water and energy transmitting water 11 into a Pyrex vessel, the bubbler, 66 at a flow rate measured by the flow meter 67 and pressurized with nitrogen through valve 69. The pressure over the coolant water and energy transmitting water 11 is maintained at a level of pressure, through pressure gauge 70, to minimize the cavitation damage to the containment elements 12, 22, 96 and 97. The cooling coil 79, made of ¼ inch copper tubing, may be positioned in a heat exchanger 165. The agitator 54 is used to stir the cooling liquid 56 in the heat exchanger.

The circulating coolant and energy transmitting liquid 11 is circulated by pump 75, moving liquid 11 from the cooling coil 79 past the thermocouple 152 and through the horn 12 (the acoustic horn generator) and into the sonication volume 81. After a short residence time, the liquid 11 moves past the thermocouple 151 then to coil 75, to the flow meter 67 and gas pressure bubbler 66, to start its passage over again. This is a heat removal cycle for the sonication system 16.

### OPERATION OF THE PREFERRED EMBODIMENT

The operation the preferred embodiment includes the general operation to produce the heat, the conditions and parameters for good heat production, and the calorimetry for the measurement of the heat production.

In operation, the system including reaction vessel 18 is evacuated and then initially charged with deuteriumoxide from 121 filling reaction volume 18, bubbler 46, coil 44 and the associated conduit lines (see FIG. 1) and the reactor pump 50. Once the reaction volume 18 and the gas introducing system 166 is charged with deuteriumoxide, argon is introduced into the upper portions of the bubbler chamber 46 by means of the valves described in the preceding discussion. Valve 88 may isolate the reaction volume 18, the heat exchange coil 44, and the bubble chamber 46 from the gas handling and vacuum line system (not shown) so that the external pressure of argon may be maintained in the reaction chamber 18. Argon is appropriate, as a noble gas, to mix with the deuteriumoxide and circulate through the reaction volume system 14. Further, the high polytropic constant of argon is helpful to the heat generating process. Other noble gases such as xenon are also appropriate because their high polytropic constant will generate a higher energy density during bubble collapse and because of their high ratio of heat capacities. During a run, pressure can be monitored by gauge 102. Following the pressurization of the system, if desired the valve 87 and 89 are briefly opened and the evacuated sample flask 94 takes a gas sample either during or after the run has been performed (usually after).

The sonicator system which includes the sonication volume 81, the heat exchange coil 79, the sonication bubbler 167, the associated conduit lines (see FIG. 1) and the sonication volume pump 75 are filled with the distilled light water (H₂O).

Once the deuteriumoxide is located in the reaction chamber 18, the light water located in the sonicator 81 and the reactor system and the sonicator system pressurized with argon and nitrogen respectively, the sonicator 76 may be activated. The acoustic waves resulting from activation of sonicator 76 puts the horn 12 in oscillation and results in the transmission of the acoustic energy through the separator 22 and the production of transient cavitation bubbles (TCB) in the deuterium oxide liquid in the reaction volume 18. The geometry of reactor volume 18 maximizes the foil area to the volume of deuteriumoxide 10 in the reaction volume 18. The acoustic waves generated in the light water 81 by the acoustic horn generator 12 causes within the acoustic wave a train of high and low pressures within the light water which pass through the separation disk and charged plate 22 into the deuterium oxide. The high and low pressures alternate sinusoidally as the frequency of the acoustic horn generator 12. Note that the pressure of nitrogen is high enough to suppress the formation of bubbles in the sonication volume 81 thus preventing cavitation damage to the containment of light water in 81. The TCBs that are formed in the reaction volume particularly those at the metal lattice and deuterium oxide interface go through a growth and collapse process. During the TCBs growth it gains mass as the acoustic pressure increases and then collapses adiabaticaly, in a microsecond, creating the high energy density of the bubble contents. The TCB collapse process creates a shock wave accelerating towards the bubble center at a rate generally faster than the bubble shell and a portion of the contents of the bubble dissociate and ionize. Also the TCB in the final stages of collapse forms a jet traveling several times that of the shell velocity which is directed perpendicular to the foil surface. The dense plasma contents of the TCB are accelerated via the jet into the metal lattice structure. The metal lattice is also set into motion (its resonance frequency) by the generated acoustic wave. The dense plasma from the jet consists of deuterons from the ionized deuterium oxide. These ions are at a very high density (as high as that found in stars) but disperse in pico to micro seconds throughout and out of the lattice. The possibility exists that a second TCB collapse at the same locale of the lattice before the first injected deuterons have completely dispersed. During the following cycle more deuterons are injected into the lattice and encounter some of the population of the first injected deuterons. The numbers of collapsed TCBs is many millions per second for a 20 Khz acoustic horn. The activity on and in the metal foil is very intense, fast and microscopic and relies on the millions of events added together to produce the heat.

The conditions for the production of TCBs and the excess heat are found in three parameters: the running temperature of the deuteriumoxide, the external pressure of argon over the deuteriumoxide and the magnitude of the acoustic amplitude input to the deuteriumoxide. It is the control of these three TCB parameters that produces events in the metal lattice producing the heat.

The TCBs may reach 40 microns in radius before collapsing and the radius depends on the three parameters acoustic amplitude, external pressure and temperature of the deuterium oxide. If the acoustic amplitude is too large or small for a given external pressure and temperature, there will be no TCB production and therefore no heat production. The same can be said for the other two parameters. These three parameters are linked together to form boundaries for the TCB production and therefore the heat production. These three parameters are discussed later in more detail. The increase in the size of the bubble during the isothermal growth phase may be 4 to 40 microns and decrease in size during the adiabatic collapse phase from 40μ to 0.1μ which produces in the order of one million increase in the energy density applying just the volume factor. The process is more complex and is still controversial depending on whose theory one believes.

The final stages of the collapse the TCB, where the bubble contents consist primarily of deuteriumoxide, and which ionizes to form D⁺ the energizing source of the anomalous heat. Then after the collapse most of the created ions revert back to deuterium oxide and other minor products. These minor products are found at small steadystate concentrations.

3D₂O+Ar→6D²⁺+3O²⁺+Ar→D₂O+D₂O₂+D₂+Ar

The calorimetry for the measurement of the heat is a cooling curve method using Newton's Law of Cooling and a calibrated Joule heater measuring the watt input at steadystate temperature to compare the sonicator heat input at steady state temperature. The device was divided into six component parts with each part having its own cooling curve independent from the others. These parts include the reactor 14, the sonicator 16, the heat exchanger 165, the reactor bubbler 166, the sonicator bubbler 167, and the associated tubing 168. The cooling curves follow the expression hAΔT for each component where h is the coefficient of natural convection, A is the surface area, and ΔT is the temperature difference between the ambient air and the surface temperature at steady state of each component. Any increase in ΔT above the calibrated inputs is the production of heat and is shown in graph 1 known heat in verses measured heat out.

### THE EXPERIMENTS

### THE FIRST ANOMALOUS HEAT EXPERIMENTS

Early experiments testing the cavitation system were performed in March and April of 1989. Temperature measurements indicated that more anomalous heat was generated in runs utilizing heavy water and deuterium-loaded palladium than in runs utilizing light water and hydrogen-loaded palladium. Further details on the results of these earlier experiments can be found in U.S. patent application Ser. No. 07/782,558 (now abandoned), a parent of this application, incorporated herein by reference.

These encouraging first experiments led to a series of experimental modifications and careful calorimetry measurements which demonstrate that, with appropriate adjustment of parameters, excess heat was consistently generated in runs lasting for 24 to 72 hours. Some of the results of these experiments were from independent and federal laboratories. The first experiments utilizing the dual circulation apparatus were started in summer of 1989, and were kept at steadystate ambient temperature with the monitored addition of ice to the heat exchanger. The present application is a modification that allows the steady state temperatures of over 100° C. to be run. Since excess heat generation may be attributed to unknown chemical reactions, it does not, in itself, establish that an exotic combination was taking place.

However, in a number of experiments helium 4 was detected. Also recently, it was found that part of the palladium lattice has been transmuted to cadmium and other isotopic ratio shifts that indicate transmutations occured with non long range radiation. The basic mechanism leading to the above combination products (nuclear ash) was probably the intense localized heating (which may reach 100 thousand of degrees Kelvin) generated inside the adiabatically collapsing cavitation bubbles. Thus far, no clearly measurable accompanying long range radiation has been detected. Measurements of radiation obtained from sophisticated neutron, gamma and tritium detection instrumentation showed only sporadic radiation above normal background levels. Alpha, beta and low energy x-ray radiation may be present but being short range in penetration characteristics the radiation was not measurable. These radiation measurements were done by outside laboratories. There was for many of the runs continuous radiation measurements with a Geiger-Mueller counter at the observation window, which was qualitative and done primarily to insure safety. Details of the experimental system and a discussion of the results and mechanisms involved are given below.

### EXPERIMENTAL METHOD (STEADYSTATE CONDITIONS)

As with earlier experiments, an acoustic generator operating at 20 Khz was used to create transient cavitation bubbles on the surface of a palladium foil 26 of dimensions 50×50×0.1 mm. It has been shown both theoretically and experimentally that a transient cavitation bubble at a metal surface in an acoustic field will collapse violently with the formation of a jet. This bubble jet accelerates the high energy density contents of the bubble into the metal lattice. The contents were similar in state to matter found in stars. (The monatomic matter behaves very much like an ideal gas with the ratio of heat capacities, γ, equal to 1.6 (polytropic constant).) Each surface bubble acts as a micro-accelerator for deuterons and other species within the bubble. The deuterons were directed into the target in accordance with the known physical behavior of collapsing transient cavitation bubbles at surface sites through the bubble's jet.

The palladium lattice target was loaded with deuterium via the bubble jet. The target was under stress from the acoustic field, from surface and bulk acoustic waves in the metal and from shock waves generated in and by the collapsing bubbles. Conditions exist for the occurrence of unique combination events, in the time frame of the acceleration of high energy density matter into the lattice. The time frame, in which the asymmetric bubble collapses violently, was less than a microsecond and occurs during the compression mode of one acoustic cycle.

### EXPERIMENTAL APPARATUS

The apparatus elements shown in FIG. 1 can be gathered into subgroups or systems called components which are convenient for calorimetric measurements as shown in FIGS. 1, 2 and 3. These components are:

(1) The reaction volume 14 made up of various elements previously described which has deuterium oxide 10 circulating through, and monitored by input 148 and output 149 thermocouples and surface thermocouple 157.

(2) The sonication volume 16 also made up of previously described elements has light water circulating through, and monitored by input 152 and output 151 thermocouples and surface thermocouple 158.

(3) The heat exchanger 165 contains the circulating deuterium oxide 10 and circulating light water 11 and is monitored by thermocouple 155 and surface thermocouple 160.

(4) The reactor system bubbler 166 has deuterium oxide 10 circulating there through, monitored by input and output thermocouples 154 and 150 and surface thermocouple 161.

(5) The sonicator system bubbler 167 circulates light water 11 monitored by input 153 and 156 output thermocouples 153 and 156 and surface thermocouple 162.

(6) The circulation conduits and pumps are grouped together as component 169 is monitored by all associated thermocouples (148, 149, 150, 154, 152, 156 and 153).

The experimental apparatus for creating the environment for this phenomenon consists of two closed circulation systems that maintain the proper external pressure and temperature so that cavitation bubbles can be produced over extended time periods with the correct amount of acoustic input. The largest system is the heat exchange system 165 in which water was circulated through the heat exchanger 56 with a volume of 15 liters, shown in FIG. 1, at a rate of 60 ml/min. An external pressure of nitrogen is maintained in the sonicator bubbler 66 to reduce cavitation in the sonication system allowing more acoustic energy into the reaction volume 18. The latter system was concentric with the sonication system 16 and was located above it. The two systems were separated by a 1 mm (40 mil) stainless steel disk 22. The reaction volume was designed in keeping a reaction volume geometry which maximizes the surface area of the foil and minimizes the volume of deuteriumoxide. In the 15 ml reaction volume 18, heavy water was circulated at a rate of 30 ml/min by flow meter 51 through the same 15 liter heat exchanger 165. The external pressures of gases were adjusted to values in the reaction volume system to optimize the character of transient cavitation bubbles. The two concentric 7.5 cm diameter acoustically connected systems were run at steady state temperature conditions (where input and output power are equal). The reaction volume 18 contained the palladium foil 26. Critical temperatures were monitored at various points in the two systems, tracking the total energy input and output with time (data was taken at five minute intervals measuring the 15 thermocouples, the two pressures and the two watt inputs from the sonicator and Joule heater). The acoustic field was generated by a 64 mm (2.5 inch) titanium acoustic horn 12 tuned to 20 KHz. The acoustic energy delivered to the Pd foil 26 was about 3 watts/cm². The containment for the sonication system and horn was ½ inch thick expandable aluminum split sliding cylinders 96 and 97. The top sliding cylinder 96 has a circular recess that houses the coiled 1/16 inch by 40 inch 400 watt stainless steel sheathed Joule heater 94 purchased from ARI Industries Inc. located in Addison Ill.. The side containment for the reaction volume is a ¾ inch thick stainless steel ring 20 with input and output ports 30 and 28.

The pressure gauges were digital compound gauges from TIF Instrument Co., measuring 30 inch Hg to 60 PSIG. The bubblers 46 and 66 were 25 ml and 100 ml Pyrex cylinders compressed at top and bottom with ¼ inch stainless steel disks with Teflon® gaskets to make the seal. The larger bubbler was in the sonication system. The gas in the reaction volume 14, reaction coil 44 and reaction bubbler 166 was argon. The gas in the sonication system sonication volume 16 sonication, coil 79 and sonication bubbler 167 was nitrogen. The flow meters were from Key Instrument, located in Trevose, Pa., with an acrylic body and a stainless steel float.

The circulating pumps 50 and 72 were ¼ inch piston displacement pumps obtainable from FMI, located in Oyster Bay, N.Y., with an alumina piston and liner and a stainless steel body, part Q1CKC, coupled with a variable speed motor, part QV. The pump's interior material exposure to the circulating heavy water was to alumina and stainless steel. The valves were stainless steel obtainable from Parker, and the Teflon® tubing and fittings were obtained from Galtek in Sunnyvale, Calif. The thermocouples were type K from OMEGA whose outputs were logged every 5 minutes by a Keithley data processing board in an IBM personal computer. The reaction volume interior material exposure to the circulating heavy water was FEP, stainless steel, Pyrex, alumina and Lucite. The input and output ports were supplied with Teflon® fittings for the FEP tubing which was used throughout the apparatus.

The electric isolation of the reaction volume was accomplished using Teflon® gaskets 108 with the sandwiching and isolating of the separating disk 22 in from the reaction volume 18 and the sonication volume. The electric isolation was completed with six 12.7 mm (½ inch) nylon bolts 38 fasting the reaction volume to the sonication volume. The sonication volume 81 was machined from an aluminum block to accommodate a 63.5 mm (2.5 inch) horn 12. The heat exchanger 165 for the reaction volume 14 and sonicator 16 was a 3/64 inch thick aluminum cylinder compressing gaskets top and bottom with two circular ½ inch aluminum plates compressing the aluminum cylinder and holding a volume of 15 liters of light water 56 as the heat exchange liquid. The hot deuterium oxide received from the reaction volume 18 passes through 20 feet of coiled ⅛ inch stainless steal tubing, element 44, then back to the reaction volume. And similarly the light water received from the sonicator passed through a 100 foot ¼ inch copper tubing heat exchange coil element 79 removes heat from the sonicator which then passes the light water back to the sonication volume. A stirrer 54 for the light water coolant 56, keeps the temperature uniform in the heat exchanger.

### MATERIALS USED

Foils used were purchased from Johnson Matthey Chemicals Limited with the dimensions of 50×50×0.1 mm and shown in FIG. 1 as element 26 with a weight of about 3 gm., except for the stainless steel foil which was purchased from Precision Brand, Downers Grove, Ill.. The foils were palladium, titanium, nickel, copper, silver, stainless steel and absence of foil. Referring to FIG. 2, the foil was held at the comers by a FEP supporter 95. The foil was positioned in a plane parallel to that of the stainless steel disk 22 and suspended in cavitating heavy water reaction volume 18. The foil was electrically isolated.

Referring to FIG. 1, the heavy water 11 was purchased from Wilmad Glass Company of New Jersey with a purity of 99.9% and was used as is. It was degassed and pressurized with argon in the sealed graduate 120 before being added to the reaction volume 18. The He4 free argon gas was purchased from Air Products located in San Jose, Calif., and used as is from the gas cylinder.

The apparatus was first cleaned then bolted together and the reaction system was pressurized with argon testing for tightness and leaks. When satisfied that the system was tight, the heavy water 121 was added to the reaction volume loop and circulated as heavy water 11, removing system gas bubbles to the bubbler 166. The next step was to add light water to the sonicator loop and its pressurization with nitrogen was the next step. The purpose of the pressurization was to reduce the cavitation in the sonication volume 81 (the acoustic pressure, which was delivered to the stainless steel disk, did not produce cavitation damage in the sonication volume because the formation of bubbles was repressed by its high external pressure of nitrogen). The apparatus was brought close to the operating temperature by filling the heat exchanger 165 with preheated light water. The heat exchanger was stirred with stirrer 54. The two pumps 50 and 75 were turned on circulating the heavy and light water through their respective systems. At this point, the reaction volume was filled with gas to the appropriate external pressure; then, the initial temperatures were measured, the sonicator amplifier 76 was turned on activating horn 12, the time was noted, and the run was started and reached its steadystate temperature following each component's heating curve which is the reciprocal of its cooling curve.

### EXPERIMENTAL EVIDENCE

Heat Measured

All experiments were run at steadystate conditions where the heat input equaled the heat output. Within the heat output is the excess heat Q(x). The comparison of the steadystate system where the heat input plus Q(x) balances the heat output for both light and heavy water runs thus reveals the unknown heat source Q(x). By carefully measuring the steady-state temperatures of each component periodically during a run, the component's contribution to the overall steadystate distribution of heat input and distribution of heat output was evaluated and compared to the identical Joule heater distribution of heat in calibration runs. The effect of changes of the system parameters such as the foil, temperature, external pressure, and acoustic input on the heat distribution of each component must be considered in the determination of Q(x) when compared to the Joule heater calibration runs. These results of the calorimetric measurements of the heat input vs heat output are listed in graph 1.

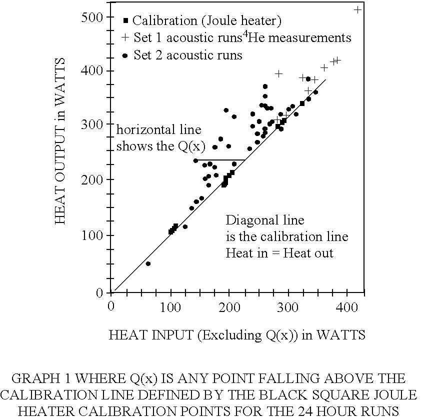

Graph—1 shows first the calibration Joule heater runs where heat input always is equal to heat output and produces the diagonal calibration line where acoustically powered runs producing no anomalous heat, Q(x), will fall on this diagonal. Those runs that produce Q(x) will produce data points that are above the diagonal calibration line. Q(x) watts must be added to the heat input watts to bring it to the diagonal. The two sets of data were collected in similar devices.

The Controlling Parameters

The three parameters that control the production of the TCBs are the temperature of the liquid, the external pressure (usually argon), and the acoustic power input to the reactor. In simple terms the three parameters are temperature, pressure, and acoustic input.

[image]

When the environment is set properly, the anomalous heat or Q(x) is produced. Graph 2 shows a three dimensional schematic picturing the Q(x) at steadystate temperature T ( watts in) and external pressure of Ar (Pₑₓₜ) as the acoustic watts, (A+B), are varied. The acoustic input (A+B) is the sum of the heat produced due to the cavitation heating, A, and the heat produced by the motion of molecules in the acoustic wave, B. The watts in equals all the measured heat inputs and the watts out equals the measured heat out including Q(x). Note the calibration curve now becomes a calibration plane where watts in is equal to watts out for all Pₑₓₜ. The production of Q(x) in watts shows its self as a skewed bell curve on and above the calibration plane in graph 2. For a given temperature (or watts in) the production of Q(x) first increases as the pressure increases, reaches a maximum, and then with further pressure increase Q(x) decreases going to zero and back to the calibration plane. Note that at steadystate conditions the Q(x) production coincides with the TCB production. As the Ar pressure varies, the Q(x) is an add on value to the calibration plane. The maximum of Q(x) increases as (A+B) increases. The maximum moves away from the calibration plane as the temperature increases. This movement is related to the vapor pressure of the D2O.

He4 Measurement

The analysis of evolved He4 was performed by independent laboratories with some of the samples analysed at Stanford Research International using a modified LKB-9000 mass spectrometer with enough resolving power to separate D2 and He4 (Runs L, M, S and A). Some samples were analyzed at the U.S. Bureau of Mines' helium analysis laboratories in Amarillo, Tex. using a carbon cold trap to remove the D2 (Run N). Some samples were analyzed at Rockwell MS laboratory in San Diego, Calif. also using a carbon filled cold trap to remove D2 from the gas being analyzed (Runs 1, 2 and 3).

The apparatus, FIG. 1, shows that isolation valves 86, 87 and 88 allow a gas sampling bulb 95 to be inserted into the reaction volume system, using fitting 90, and evacuated, collecting a gas sample which can be analyzed for He4. The 50 ml sampling flask 95 was equipped with an isolation valve 89. The gas transferred into the sample bulb was only a portion of the total gas available from vessel 46. The simple volume and pressure relationships of the ideal gas laws were used to calculate the atoms of He produced during the run from the parts per million of He4 found in the flask 95 via the MS analysis. Some of the evolved He4 in the reaction system was probably trapped in the lattice and D₂O, and will require a specialized technique to remove it for measurement. After the transfer of the gas from the reaction volume system into the sample bulb 95, the pressure was measured by pressure gauge 102. The sample bulb was removed from the system with wet gases trapped inside ready for the MS analysis.

A typical mass spectrum of a sample contains a small amount of He4, some D₂, some HD and H₂. In the Rockwell laboratory there was analysis for He3 as the various hydrogen species were removed using the carbon filled gas trap. The amount of He4 that one might expect from the natural background was about 5 ppm.

TABLE 1
THE CONVERSION OF MEASURED He4 TO HEAT
AS A PARTIAL SOURCE OF Q(x) - MS RESULTS

| | | He4 | Q(x) | CALC. |
|---|---|---|---|---|
| | OUTPUT | ATOMS | WATTS | WATTS |
| RUN | WATTS | 10¹⁴ | FROM He4 | Q(x) |
| L | 420 | 200 ± 200 | 1 ± 1 | 31 ± 10 |
| M | 418 | 1400 ± 200 | 6 ± 1 | 30 ± 10 |
| S | 404 | 2500 ± 800 | 11 ± 1 | 30 ± 10 |
| A | 382 | 800 ± 200 | 3.5 ± 1 | 21 ± 10 |
| N | 385 | 1400 ± 200 | 6 ± 1 | 40 ± 10 |
| 1 | | 12 ± .05 | .004 ± .001 | * |
| 2 | | 68 ± 1 | .27 ± .01 | * |
| 3 | | 14920 ± 20 | 67 ± .5 | * |

Table 1 shows the collection of runs that produced a measurable amount of He4 from MS analysis. The generation of He4 accounts for some of excess heat measured for the runs. Column 1 is the run designation. Column 2 is the number of He4 atoms produced. Column 3 are the number of Q(x) watts produced from the He4 production. Column 4 is the total Q(x) produced in watts. The runs 1, 2 and 3 were analyzed without the Q(x) analysis designated by the * in column 4. These analyses indicate that a portion of Q(x) can be accounted by the He4 production and the rest by other phenomena.

Visual Heat and SEM Evidence

On many occasions following the heavy water-deuterium runs, the palladium foil was found to be discolored with lattice formations and compared in appearance to what one might expect from an overheated metal foil. On numerous occasions, the foil partially melted, displaying both high discoloration and prominent holes up to 5 mm in diameter in the 50 mm square foils. The heat required to produce these holes in the foil was dependent on the duration and the intensity of the acoustic input. There was enough energy to melt the foil in the known heat dissipating environment, D2O, of the reaction volume. Rough estimates of the power in the largest pulses producing these holes must be in the megawatt range to have caused the damage seen in the palladium lattice. In the light water runs, there was slight discoloration and deformation.

The Palladium Foil Analysis

The He4 found by MS analysis does not account for all the excess heat. If DD combination events occurred in the palladium lattice, then perhaps there were other high energy events that followed, energized by the DD events, causing small changes in the palladium lattice isotope distribution and perhaps some other transmutation. Other possibilities for the generation of excess heat Q(x), such as transmutations in the cavitation exposed palladium lattice, could be found by analyzing the exposed palladium foil, using an Inductively Coupled Plasma Mass Spectrometer (ICP-MS).

In an independent laboratory, a comparative analysis was made of before and after cavitation-exposed palladium samples using a Perkin Elmer Sciex Elan 500 ICP-MS, with a resolution of one mass unit. This analysis looked for changes in the before and after exposure of the metal palladium lattice samples, and was done six months after the completion of Experiment 9.

The palladium foil, which had a purity of 99.9975%, used in runs I, J, K, L, M, R, and S of Experiment 9, had a certified elemental analysis by the vendor for 72 elements. The lattice impurities of interest for this particular analysis were rhodium at less than 3 ppm, silver at less than 1 ppm, and cadmium at less than 1 ppm (below the level of detection of the certified elemental analysis). The ICP-MS analysis measured small differences in isotope concentrations of metal impurities in palladium foil lattice with masses similar to those of the palladium isotopes. The two palladium samples were dissolved in nitric acid, 0.024 gm before and 0.022 gm after exposure, and analyzed.

Most of the suspect stable transmuted isotopes in the mass range of interest were blocked from analysis by the high concentrations of the stable isotopes of palladium foil. Table 2 shows the ICP MS background levels of masses (column #2) at mass numbers 112, 113, 114 and 116. These levels are subtracted from the before (column #3) and after (column #4) measurements of the samples and then the results of the before and after are subtracted yielding the ppm of the Cd isotope in the sample (column #5). The isotopes Cd 112 and Cd 114 are the only isotopes found in excess, with a value of 17 and 39 ppm, and isotopes 113 and 116 are much below their expected values to project their correct isotopic ratios.

Small differences in ion counts from the two dissolved palladium samples, before and after, were measurable only for those isotopes that were not blocked by the palladium isotopes. It would be of interest to measure any changes in the palladium isotope distribution, but these changes would be very small in the palladium rich system and therefore impossible to detect. This blocking limited detection of possible transmutations to the two cadmium isotopes Cd112 and Cd114, with the isotopes Cd113 and Cd116 not likely transmutation candidates. Only for the isotope Cd114 was the difference in ion counts, equivalent to 39±10 ion counts, statistically significant as an analytical result.

TABLE 2
LISTING OF ANALYSIS VALUES AND RESULTS
FOR THE ICP-MS ISOTOPE ANALYSIS
FOR CADMIUM IN THE PALLADIUM FOIL

| | 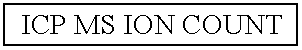 | | | | 6 | 7 |
|---|---|---|---|---|---|---|
| 1 | 2 | 3 | 4 | 5 | CADMIUM | % NATURAL |
| REACTION | BLANK | BEFORE | AFTER | CHANGE | ISOTOPE | ABUNDANCE |
| No measured Rx | | | | — | Cd¹¹¹ | 12.75 |
| Pd¹⁰⁸[He,]Cd¹¹² | 11 ± 2 | 17 ± 7 | 34 ± 9 | 17 ± 10 | Cd¹¹² | 24.07 |
| Ag¹⁰⁹[D,]Cd¹¹³ | 11 ± 3 | 18 ± 5 | 28 ± 7 | 10 ± 8 | Cd¹¹³ | 12.26 |
| Pd¹¹⁰[He,]Cd¹¹⁴ | 13 ± 1 | 12 ± 4 | 49 ± 9 | 39 ± 10 | Cd¹¹⁴ | 28.85 |
| No Pd¹¹² isotope | 13 ± 1 | 32 ± 8 | 36 ± 6 | 4 ± 10 | Cd¹¹⁶ | 7.58 |

The above result could be attributed to a redistribution of a cadmium contaminant in the system in the course of heavy water-deuterium runs. If such contamination was present, it would have led to an increase in all cadmium isotopes. In particular, if a level of the isotope Cd116 had been found, contamination could explain the analytical result. On the other hand, there being no Pd 112 isotope, no Cd116 could have been formed through the addition of an alpha particle to a palladium. The latter was the case; there were no measurable differences in the ICP-MS ion counts for the isotope Cd116. The presence of Cd114, without the presence of Cd116, points to a transmutation mechanism rather than to a cadmium contamination source.

TABLE 3
TRANSMUTATION ENERGY DUE TO THE PRODUCTION
OF Cd114 FROM Pd110 - ICP MS RESULTS
Pd110 + Cd114 27.1 Mev

| | | Pd 3 gm | | |
|---|---|---|---|---|
| | | Produced | | |
| | TIME | 39 ppm | | Cd114 |
| RUNS | SEC. | Cd 114 | JOULES | WATTS |
| ALL | 500000 | 39 | 1.9 × 10⁶ | 4 ± 2 |

Table 3 shows all the runs put together in Experiment 9 which produced a measurable amount of Cd114 from the analysis of the palladium foil by ICP MS. The Cd114 was found in the exposed 3 gm palladium foil lattice. The generation of Cd114 accounts for a small portion of Q(x) measured for the runs I, J, K, L, M, R and S.

### DISCUSSION

The subject of this invention is the demonstration of the collapse of small bubbles in an acoustic field, in a specified environment, producing heat in excess of the input energy, with the concurrent evolution of He4, and other heat producing events in a device that collects and distributes the total energy output. The preferred embodiment device pictured in FIG. 1 is composed on two vacuum tight systems, the reaction volume and the sonification volume, each with their own sensor, that enables the measurement of heat and the collection and analysis of gases produced in the reaction volume. The device has been monitored for radiation products by both in-house and outside laboratories. The result of these on-line radiation measurements of gamma and neutron was equivalent to the background levels. The measurement of residual radiation from tritium in deuteriumoxide from short-lived species in palladium and other metals shows little activity over background. These measurements show there is no apparent radiation hazard.

The energy is produced in the metal in the reaction volume which shows evidence of anomalous heat, enough to melt and in some cases to vaporize the metal. The electron scanning microscope analysis of the surface of the heated metal depicts the micro nature of the damage to the metal lattice. The damage that occurs in the lattice is not from the micro bubble's collapse, which are 0.5 microns in diameter at the time of complete collapse on the surface of the metal. The collapse is adiabatic and occurs in less than a micro second forming a jet of dense plasma-like material which is injected into the lattice. In the SEM photos the 1μ metal spheres and the ejecta sites are larger than the last stage of the collapsing TCB and therefore cannot be directly associated with the ejecta sites. The ejecta sites are caused by a process within the lattice of the metal. The contents of the bubble are important to the process which generates the excess heat in the metal lattice. In the bubble are molecules containing deuterium that are heated and pressurized by the adiabatic collapse to the point that molecular bonds do not exist. For an instant, a few picoseconds, the dense deuteron plasma is accelerated into a metal lattice that is locally super loaded with deuterium. The 20 KHz acoustic field produces a fresh crop of transient cavitation bubbles with every cycle, as many as a million, and a portion of these will sit on the metal lattice. The rate of deuteron producing He4 events in the lattice accounts for some of the excess heat output from the reaction volume.

The parameters that permit cavitation are the acoustic energy input, the temperature of the liquid and the external pressure over the liquid. If any of these three parameters are outside the cavitation envelope, no events or cavitation should occur, as shown in graph 2. An envelope is created by the three parameters P(ex), (A+B) and T° C., showing the best operating conditions of the device. In the environment of this envelope, where TCBs are born, grow, and collapse on metal surfaces, conditions exist for the production of the anomalous heat, the generation of the He4, and the transmutation in the metal lattice. The operation of the device at steadystate conditions in this envelope is necessary for the production of excess heat, Q(x). As one increases the temperature and pressure, maintaining the same acoustic field, there will be an increase in the efficiency of the anomalous heat production. As one increases the acoustic field and pressure, maintaining the same temperature, there will be an increase in the efficiency of the excess heat production. The steadystate running of the device is a way of keeping the system operating within the parameter envelope. The heat generated must be removed at a rate not to adversely affect the cavitation events, and not to cause the system to move out of the parameter envelope. (see graph 2)

The lattice is most affected by the collapsing surface bubble, which accelerates its contents into the lattice via the formation of a bubble jet. The shock wave at the point of jet injection of the bubble contents into the lattice and the temperature of the contents of the jet produces some local heating of the lattice but not enough to create the observed lattice damage. The local loading, in the short time frame, of deuterons into the lattice are for a short time way over unity (PdD). Another bubble cycle following in 50 microseconds with a collapse in the same locale provides a very highly loaded and high temperature metal lattice micro volume where energy producing events may occur. These events are governed by kinetic factors. The rate of diffusion of a proton in the Pd lattice is about 1 mm/hr at 298° K with the rate increasing as the temperature of the local lattice increases.

### FIRST ALTERNATE ANOMALOUS HEAT PRODUCING EMBODIMENT

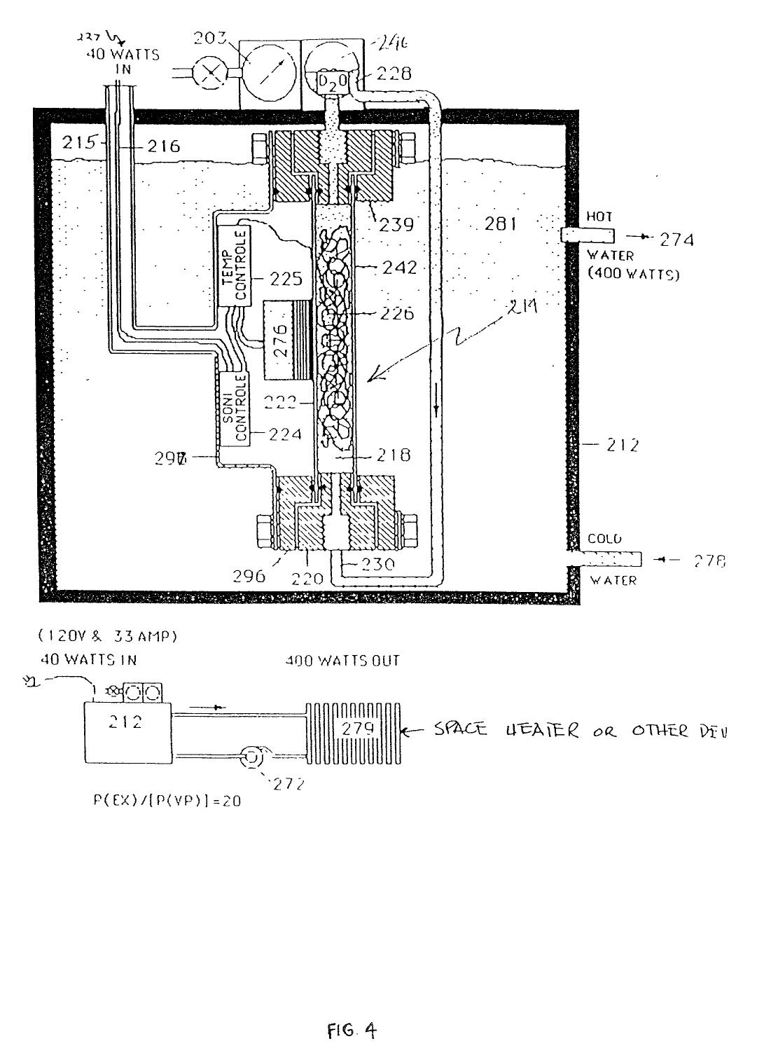

Referring now to FIG. 4, an alternate embodiment of the anomalous heat producing device described above follows.

In this particular embodiment, the heat generated within the reaction vessel 218 is surrounded with heat exchange liquid 281.

The system depicted in FIG. 4 includes a piezoelectric crystal or ceramic crystal sonicator 276, which is positioned adjacent to the reaction vessel 218 and which is immersed in a cooling medium 281. This particular cooling medium 281 is comparable to the cooling system described in the principal embodiment. However, in this particular embodiment it completely surrounds the reaction vessel rather than being just beneath it. In like manner, a coolant pump 272 will circulate water into and out of this cooling medium 281. An appropriate heat exchanger and the like may be affixed to the structure in a manner similar to the principal embodiment, within the containment vessel 212. (Containment vessel 212 is used in a descriptive sense to indicate that the entire structure may be contained within one vessel.) The reaction vessel 214 is positioned in the center of such containment vessel, with the cooling medium 281 surrounding it within the containment vessel. Entering into the containment vessel is a control stem 215 which is used to provide conduit means for appropriate conductors 216 leading to the sonicator power lines 227. Other control devices, such as temperature indicating and controlling devices 225 and sonicator power supply 224, may be positioned adjacent to the control stem 215 with the necessary electrical leads. In order to provide deuterium oxide and deuterium to the reaction vessel 214, conduits 228 and 230 are provided to the reaction vessel. These conduits may be used in a manner similar to the conduits in the principal embodiment to control to a degree the heat within the reaction vessel, should such control be necessary.

The containment for the liquid in reactions volume system 214 the circular machined aluminum center piece 220 with “O” gaskets, stainless steel disk 222 with the attached piezo 276 and the stainless steel disk 242. The target material 226 is shown as a metal wool with other configurations acceptable. The outside containment and seal for the reaction volume 214 provides for two circular machined aluminum rings 239 and 296 all bolted together to form the reaction volume. The controls and piezo are contained and sealed in the stainless steel cover 297 The excess heat generated in reaction volume 218 is exchanged with the fluid 281 of the containment system. On the other hand, it may be appropriate to keep the structure at a heat somewhat higher than in the principal embodiment, thereby depending upon coolant medium 281 to distribute the heat produced in 214. In that vein, a conduit 274 and return conduit 278 may be provided to the coolant medium 281 so that water or heat transfer material may be circulated by pump 272 to the containment vessel. The external pressure over the liquid of 218 is monitored by gauge 203. Finally, an appropriate power line 227 is provided to the sonicator power supply 224.

Operation of the First Alternate Embodiment

Operation of the alternate embodiment follows generally that of the principal embodiment. The heat generated in reaction volume 218 with the interaction of cavitation bubbles on the surface of Pd wool or wire 226 is removed quickly through the thin wall 242 and the liquid circulated through heat exchange device 279. The hot liquid 218 circulates cool liquid via conduits 228 and 230 through a convection mechanism carrying any bubbles formed to bubbler 246.

### SECOND ALTERNATE ANOMALOUS HEAT PRODUCING EMBODIMENT

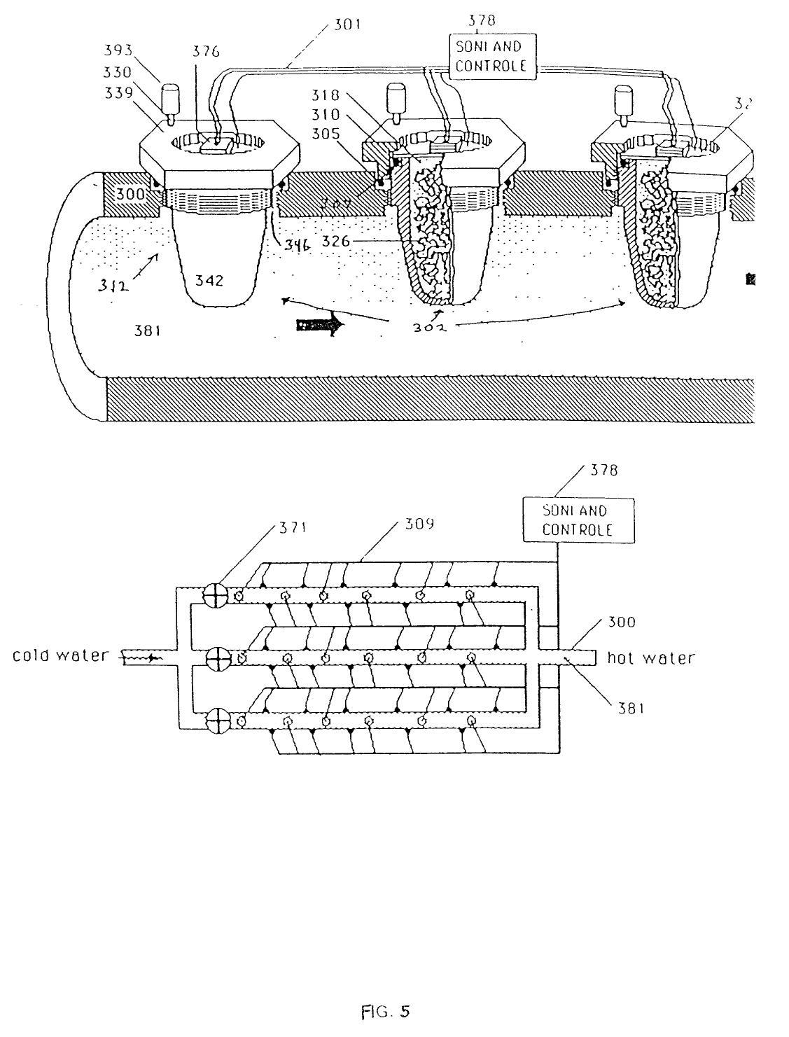

Now referring to FIG. 5, the second alternate embodiment of an anomalous heat device is shown, consisting of multiple small devices 302 that are closed systems acting in concert. These devices, similar in function to the first alternate embodiment, take the sum of the heat generated in all mini devices in the flow pipe system 300 and in the fluid 381, circulate it, and use the heat for some specified purpose. The heat generated within reaction volume 318 is in the fashion of earlier stated technology. The acoustic energy is supplied by the piezoelectric crystal 376 via electric conduit 301 which also transfers temperature information to soni-control 378 for control of the heat transfer for all of the mini devices. The piezo crystal 376 is bonded to the metal membrane 322 which is in contact with the deuteriumoxide in volume 318. Also in volume 318 is the palladium wire or wool 326 which provides the surface and lattice for the heat producing combiation events. The threaded hex sealing nut 310 seals the acoustic membrane 322 via “O” ring 307 to the body 342 of the reaction volume. The volume 318 is equipped with a filling port 330 and pressure release valve 393. The mini devices are sealed into the tube or heat flow pipe 300 via threaded element 346 and “O” ring 305.

Operation of the Second Alternate Embodiment

Operation of the second alternate embodiment follows generally that of the principal embodiment. The heat generated in reaction volume 318 from the interaction of cavitation bubbles on the surface of Pd wool or wire 326 is removed quickly through the wall of 342. The liquid in 342 relies on convection from the wire 326 to the liquid contained in reaction volume 318, then through the wall of body 342. Here the heat is transferred to the circulating liquid 381 and carried to the point of use. In summary, the heat generated by combination events is transported by pipe 300 circulating liquid 381 at a rate controlled by valves 371 (see FIG. 5) to a device similar to that found in the second alternate embodiment. The mini anomalous heat cells embedded in the pipe 300 serve to provide constant and even heat to the circulating liquid which can be extracted at some point downstream for the users' benefit, then returned as cool liquid for reheating and reuse.

### THIRD ALTERNATE ANOMALOUS HEAT PRODUCING EMBODIMENT

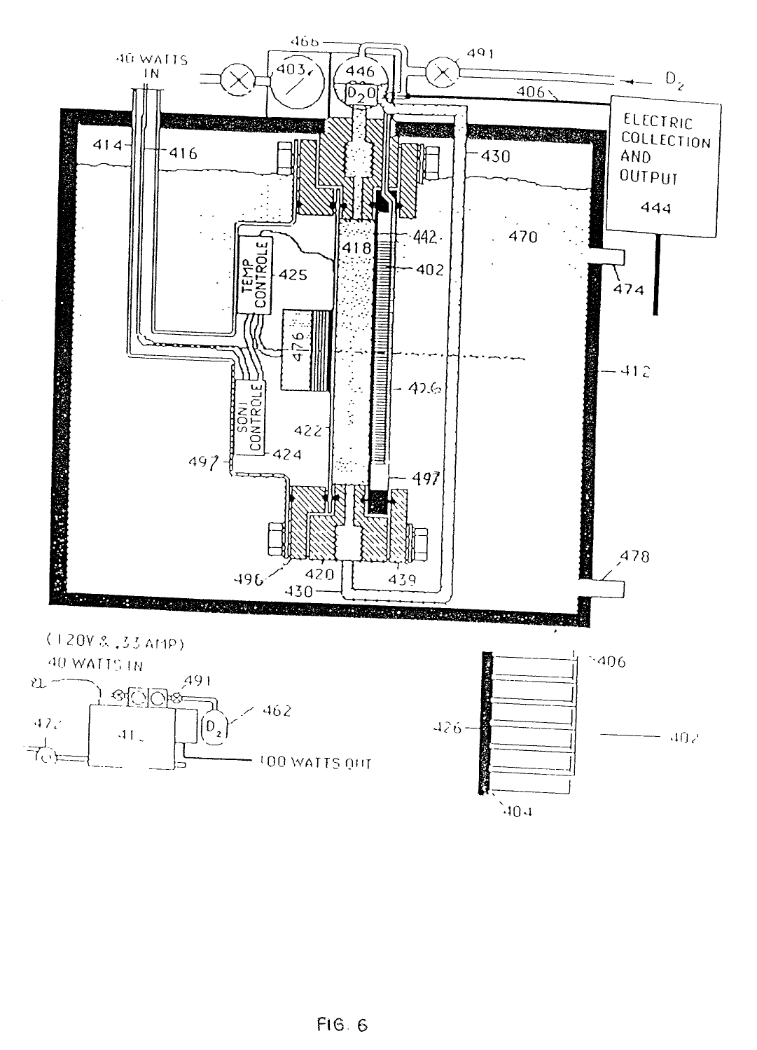

Now referring to FIG. 6, the third alternate embodiment of an anomalous heat device is shown. In this embodiment, the heat generated within the reaction vessel 418 is converted to electricity or electrical current by means of a thermoelectric device 402 (TED) using the heat differential developed between the palladium lattice 442 and the heat exchange fluid 470. The TED 402 can take the configuration shown schematically in FIG. 6, which is a series arrangement. A temperature gradient exists between the two elements 442 and 470. The system depicted in FIG. 6 includes a piezo stack 476 mounted on metal disk 422 forming a wall of reaction volume 418. The reaction volume 418 is immersed in a heat exchange liquid 470 contained in an insulated box 412. In the reaction volume 418 is a metal foil 442 that is part of containment 418. The entire system is contained in the box 412 so as to capture most of the heat generated by all factors (cavitation, electronics, and lattice events). The sonicator 476 is protected, as is the power supply and control for the sonicator 424 and the temperature sensing and control 425, from the liquid 470 by shield 497, keeping the electrical components therein dry. The TED 402 is a sealed volume which consists of the palladium 442 and the outer wall 497, and can be filled with deuterium or Ar gas 462. The reaction volume is situated in the center of confinement vessel 412 with the heat exchange liquid surrounding it within the containment vessel. Entering into the containment volume is stem 414 which is used to provide conduit means for appropriate conductors 416 leading to the electric input for the sonicator 476. Another conduit 466 performs the function of (1) allowing deuterium or Ar pressure to both the reaction volume 418 for the purpose of keeping the deuterium at optimum operating pressure in the reaction volume 418, and (2) acting as a conduit for the electric energy transported to the outside of containment 412 by leads 406. Other control devices for measuring pressure and temperature can be placed near either conduit 466 or 414 as a matter of practicality. In order to provide deuteriumoxide to the reaction volume 418, the conduit 466 can be used. The circulation of deuteriumoxide through the reaction volume 418 is via convection with the hot liquid in 418 rising into volume 446, then settling down after cooling through conduit 430 and traveling back into the reaction volume 418 through the bottom. The control of the temperature of the system is maintained at a steady state to maintain the best environment for cavitation. It may be appropriate to keep the fluid 470 cool by circulation to the outside environment for heat exchange via conduits 478 and 474 by pump 472.

Operation of the Third Alternate Embodiment

Operation of this alternate embodiment follows generally that of the principal embodiment; however, in this instance, a sonicator is operated adjacent to the reaction vessel 418, thereby causing combination reactions to occur in the palladium-faced thermoelectric device TED 402. Anomalous heat events raise the temperature at the hot junction 426 of the TED creating an electrical current within the system. Such current is tapped off through lead 406. A positive deuterium or Ar pressure is maintained in the reaction volume 418.

### FOURTH ALTERNATE ANOMALOUS HEAT PRODUCING EMBODIMENT

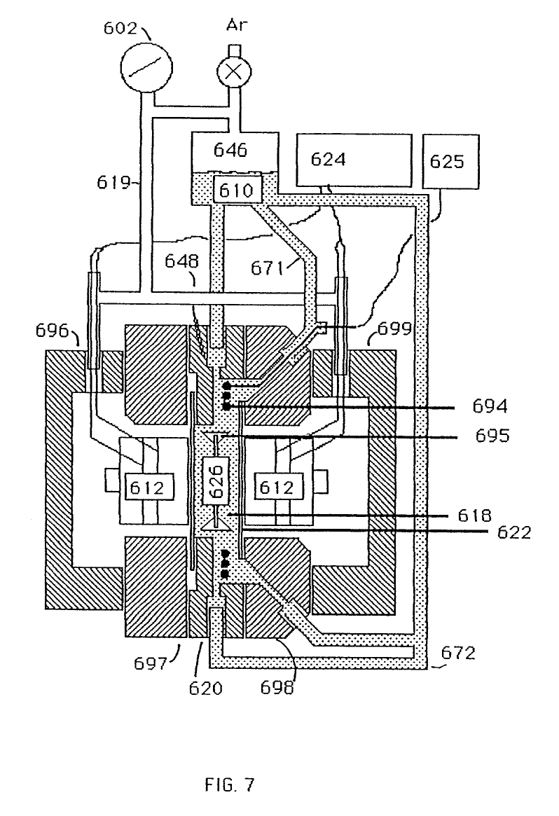

Referring now to a fourth alternate embodiment which is an immersible unit using opposing piezos in a static device for heating water is shown in FIG. 7. The device functions as a water heating unit. In this embodiment, the purpose of the device is to use the opposing piezos to drive acoustic waves through the water creating cavitation bubbles on both surfaces of the metal foil. The relative amount of acoustic energy input into the foil can be pulsed taking advantage of the acoustic intensity without the too much heating. Conditions can be met that makes anomalous heat production very reproducible.

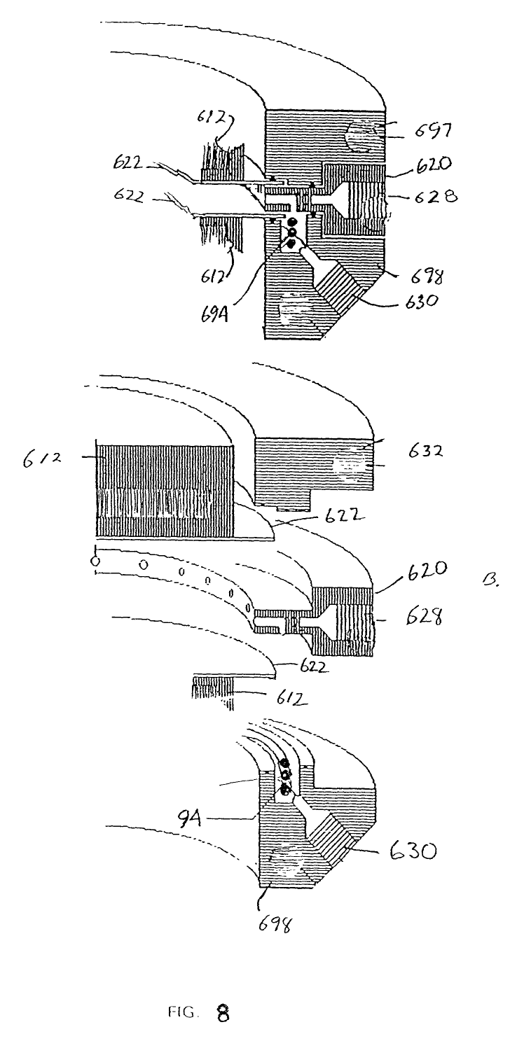

The system depicted in FIG. 7 has an embodiment very similar to the first alternate embodiment shown in FIG. 4. It includes two piezoelectric stacks 612 which produce the TCBs that collapse on the target surface bonded to stainless steel disks 622. The acoustic energy broadcast into the water 618 surrounding the metal foil 626 in the reaction vessel produces anomalous heat that is collected along with the heat used in its production. The total heat is converted and directed into useful tasks. The fluid 610 is comparable to the reactant fluid contained in 14 described in the principal embodiment. The fluid is circulated between 610 and 618 via convection through the system's exit ports 628 and input ports 630 (see FIG. 8). The reaction volume is made up of disks 622 and aluminum containment ring 620 and the and contains the target foil 626 and the Joule heater 694, which is sealed to the body of the reaction volume via sealing aluminum rings 697 and 698, “O” rings, Teflon flat gaskets and bolts. The containment for the two piezos are the aluminum caps 696 and 699 which allow the pressure in reaction volume and the piezo containment to be equal which is accomplished through conduit 619. This pressure is measured by gauge 602. Other control devices such as temperature measuring thermocouples 648 and also pressure controlling devices 602 may be positioned for efficient use with the necessary electrical leads and data collection. In order to provide bubble free water to the reaction vessel, a liquid input device 646 is positioned above the reaction volume 618. Finally, an appropriate water immersible power supply 624 is provided to power the two piezos 612. The target material 626 for the anomalous heat production is placed in the reaction volume 618 and held in place by holder 695.

Operation of the Fourth Embodiment

Operation of the fourth alternate embodiment follows generally that of the principal embodiment except that there are two opposing piezos and there is only one stage. The device is fully immersible converting the heat input as well as the produced anomalous heat into a usable resource.

While this invention has been described in relation to specific embodiments, the invention should not be so limited but rather is limited only by the appended claims.

I claim:

1. An anomalous heat producing apparatus comprising:
a reaction vessel;
a reactant material either in liquid form, dissolved in a liquid or mixed with a liquid, the reactant material selected from the group consisting of hydrogen (H₂), hydrogen oxide (H₂O), deuterium (D₂), deuterium oxide (D₂O), hydrogen deuterium oxide (HDO), or mixtures thereof; linear alkanes, metallic hydrides, paraffins and silicones wherein at least one of the hydrogen atoms is isotopic hydrogen, said reactant material contained in said reaction vessel;
an energy source to excite said reactant material;
a catalytic material, metal or alloy substrate, a substantial part of which is selected from the group consisting of copper (Cu), nickel (Ni), titanium (Ti), palladium (Pd), or silver (Ag), said catalytic material, metal or alloy also contained in said reaction vessel and for providing a matrix configuration to position atoms of the reactant material in a manner to optimize controlled combination;
and means for conducting away heat from said reaction vessel.

2. The apparatus of claim 1 wherein the energy source is selected from sonic, mechanical, electrical, optical, magnetic or a combination thereof.

3. The apparatus of claim 2 wherein the energy source is focused sonic waves.

4. The apparatus of claim 3 wherein the metal or metal alloy comprises palladium.

5. The apparatus of claim 4 wherein the reactant material is selected from deuterium oxide, deuterium or mixtures thereof.

6. The apparatus of claim 1 wherein the apparatus further includes metal or metal alloy shielding to collect produced alpha-particles.

7. The apparatus of claim 1 wherein the apparatus further includes means to collect any helium gas produced.

8. The apparatus of claim 1 wherein the energy source is a sonic wave generator.

9. The apparatus of claim 1 wherein the reactant material comprises deuterium and the catalytic materials, metal or alloy substrate comprises palladium present in at least 99 percent by weight.

10. The apparatus of claim 1 wherein the palladium is present as a finely divided powder, a fine mesh screen, a thin band of palladium from 1 to 10 microns in thickness, a palladium foil to 40 microns in thickness, or a palladium tipped thermoelectric device.

11. The apparatus of claim 1 wherein the reactant material is in a liquid form and further wherein the energy source is focused sonic waves of sufficient energy to cause cavitation bubbles to form in the liquid reactant material.

12. The apparatus of claim 11 wherein the reactant material comprises deuterium and the catalytic materials, metal or alloy substrate comprises palladium present in at least 99 percent by weight.

13. The apparatus of claim 12 wherein the metal or metal alloy comprises palladium.

14. The apparatus of claim 13 wherein the reactant material is selected from deuterium oxide, deuterium or mixtures thereof.

15. The apparatus of claim 11 wherein the catalytic material is palladium present as a divided powder where the particle size exceeds the cavitation bubble size.

16. The apparatus of claim 1 wherein the means for conducting heat away from said reaction vessel includes a circulation system and a heat exchanger positioned exterior of said reaction vessel, said circulation system for circulating the reactant material between said reaction vessel and said heat exchanger.

17. The apparatus of claim 1 further including means to separate any helium or helium isotopes formed in said reaction vessel from combination of the reactant material within said reaction vessel.

18. The apparatus of claim 1 wherein the means for conducting heat away from said reaction vessel includes bimetallic thermoelectric means for converting heat of combination within said reaction vessel into electrical energy.

19. The apparatus of claim 17 wherein the reactant material is in a liquid form and further wherein the energy source is focused sonic waves of sufficient energy to cause cavitation bubbles to form in the liquid reactant material.

20. The apparatus of claim 18 wherein the reactant material comprises deuterium and the catalytic materials, metal or alloy substrate comprises palladium present in at least 99 percent by weight.

21. The apparatus of claim 19 wherein the metal or metal alloy comprises palladium.

22. The apparatus of claim 21 wherein the reactant material is selected from deuterium oxide, deuterium or mixtures thereof.

23. A method of obtaining controlled combination of isotopic hydrogen, which method comprises:
(a) forming a metal or metal alloy matrix comprising palladium into a matrix structure;
(b) contacting the metal matrix with one or more reactant compounds which comprise isotopic hydrogen, such that the isotopic hydrogen atoms are within the range where nuclear repulsion ordinarily occurs for said isotopic hydrogen atoms;
(c) subjecting the matrix and reactant charge to nuclear repulsion compounds with energy sufficient to excite the reactant compounds; and
(d) producing controlled combination thereby producing excess heat, gamma rays, and helium or a helium isotope.

24. The method of claim 23 wherein the metal or metal alloy comprises palladium in 99.9 percent by weight or greater, the reactant compound comprises deuterium, and the energy source is acoustic and utilizes cavitation micro-bubble technology to produce the focused energy to obtain controlled combination.

25. An apparatus for producing heat, said apparatus comprising:
a reaction vessel comprising an inlet and an outlet and opposed walls;
a bubble collapsing metal surface in between said opposed walls, said metal surface capable of absorbing a hydrogen isotope;
means for producing transient asymmetric high energy bubbles directed against said metal surface in a liquid medium, when said liquid medium is present in said reaction vessel;
means for heat transfer from heat produced in said reaction vessel to a heat receiving means.

26. A apparatus according to claim 25, wherein said bubbles producing means is a sonicator capable of producing sound waves at at least about 10 KHz to provide energy at said metal surface of at least about 1 W/cm².

27. A apparatus according to claim 26, wherein said sonicator comprises a liquid reservoir at an elevated pressure, said reservoir sharing a thin wall with said reaction vessel, said thin wall opposite said metal surface.

28. A apparatus according to claim 25, wherein said wherein said metal surface is a metal of Groups IV to VIII of the Periodic Chart.

29. A apparatus according to claim 25, wherein said heat transfer means comprises a circulation system and a heat exchanger positioned exterior to said reaction vessel.

30. A apparatus according to claim 25, wherein said heat transfer means comprises a bimetallic thermoelectric means for converting heat into electrical energy.
